(19) United States
(12) Patent Application Publication
(10) Pub. No.: US 2008/0115542 A1
(43) Pub. Date: May 22, 2008

(54) CABLE LOCKING DEVICE

(76) Inventor: Keith PENGELLY, Suffolk (GB)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/560,892

(22) Filed: Nov. 17, 2006

(51) Int. Cl. E05B 73/00

(52) U.S. Cl. 70/18

(57) ABSTRACT

A known locking device for preventing the theft of golf clubs held in a stand includes a cable defining a noose that fits through the hem of a hood covering the heads of the golf clubs. The cable passes through a handle of the stand and around a fixed object. The ends of the cable are fitted with eyes and are connected together with a padlock. A problem with this arrangement is that the noose can be loosened by a thief, allowing removal of the hood and then of the clubs.

The problem is solved by the use of a locking sleeve (6) that can be adjusted between a release condition in which it can slide along the cable (4) to tighten or loosen the noose (3A) and a secured condition in which it is restricted from sliding. Means is included for locking the sleeve in its secured condition so that the clubs cannot be removed.

### FIELD OF THE INVENTION

This invention relates to a locking device and is particularly applicable to act as a deterrent against the theft of golfing equipment.

### BACKGROUND OF THE INVENTION

Many proposals have been made in the past for preventing the theft of golfing equipment when left unattended. One such proposal is described in patent specification US2003/0145928 and employs a flexible cable attached to a hood that fits over the heads of golf clubs contained in a stand. In this known proposal the cable passes through a seam of the hood, through a handle and around the legs of the stand and around a fixed object. A padlock is secured through eyes fixed to the cable ends and through a loop in the cable formed by a sliding cinch. In this way it is proposed that removal of the entire bag, or of the clubs from the bag, will be prevented.

A problem of this known proposal is that the part of the cable passing through the hood seam can be loosened by a thief by adjusting the position of the sliding cinch. This allows removal of the hood and then of the clubs. This invention addresses the aforementioned problem.

### SUMMARY OF THE INVENTION

The invention provides a locking device comprising a flexible cable characterised by: a noose formed by the cable for holding one or more objects to be secured; a locking sleeve that can be adjusted between a released condition in which it can slide along the cable to tighten or loosen the noose and a secured condition in which it is restricted from sliding along the cable; and locking means for locking the sleeve in its secured condition.

In a preferred arrangement, the noose is arranged to that it draws together the edge of a bag, hood or cover so as to retain, within it, articles to be secured. However, there are many other possibilities and a similar bag could be used for containing other objects susceptible to theft, particularly objects which do not have openings through which the cable can be passed or which require the protection of a cover to prevent damage.

In a preferred construction a facility is included to lock the opposite end of the cable to the sleeve so as to form a loop passing through or around an immovable object and/or to other items to be secured eg a bag or stand in which golf clubs are held.

The inventor has devised a particularly effective form of locking sleeve. In this design the sleeve is formed from two parts, each having an axial passage through which the cable passes. The two parts have co-operating screw threads allowing them to be screwed one into the other. This screwing action, via a pressure transfer cylinder, compresses a deformable bush or washer of rubber-like material. This causes the bush or washer to deform so as to apply pressure against the cable; making it very difficult to slide the sleeve in a direction so as to open the noose. There are many variations on this design. For example, the deformable bush or washer could be replaced by other known mechanisms for gripping onto an axial member eg those conventionally used in the design of chucks for holding tools or work pieces during machining.

In designs where the sleeve is formed from two rotatable parts, it is possible to provide these parts with holes which align with each other when in the secured position. The shackle of a lock can then be passed through these aligned holes and may also be attached to a second end of the cable, which is preferably formed with a loop for that purpose.

The use of a sleeve as described above for providing an anchorage onto a flexible cable, such as used in a cable locking device, is considered to have independent inventive merit and thus, according to a second aspect of this invention, there is provided a mechanism for making a physical attachment to a flexible cable characterised by a sleeve through which the cable passes, the sleeve being formed from two co-axial screw threaded members and a pressure application member constructed and arranged so that, when the screw threaded members are turned, one relative to the other, the pressure application member deforms and is pressed against the surface of the cable thereby locking the mechanism at its current position along the cable.

### BRIEF DESCRIPTION OF THE DRAWINGS

One-way in which the invention may be performed will now be described by way of example with reference to the accompanying drawings in which:

FIG. 1 is a perspective view of a golf bag and set of golf clubs secured against theft using a locking device constructed in accordance with the invention;

FIG. 2 is a detailed view of the locking sleeve and hood shown more generally in FIG. 1.

FIGS. 3 and 4 are side elevations of two respective parts of a locking sleeve forming part of the locking device;

FIG. 5 is a cross-section through the line V-V of FIG. 2; and

FIG. 6 is a cross-section through the line VI-VI of FIG. 3; and

### DETAILED DESCRIPTION OF THE INVENTION

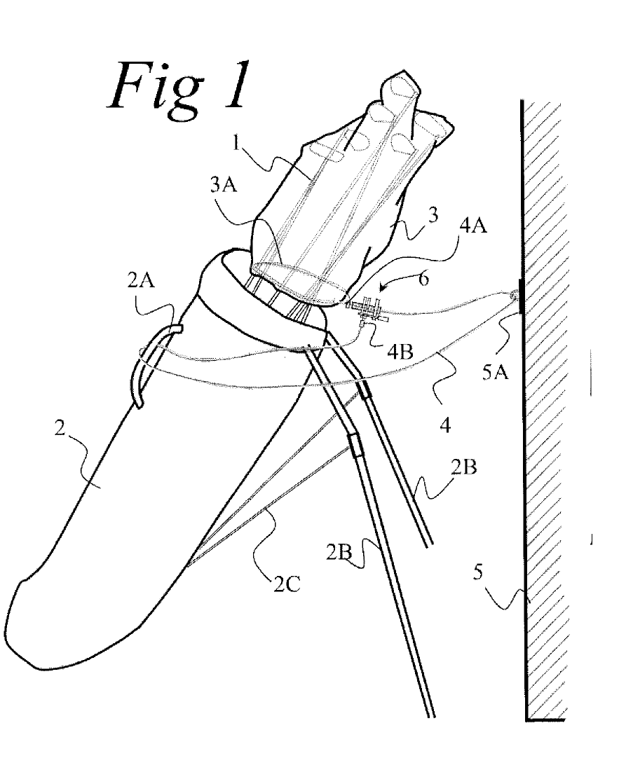

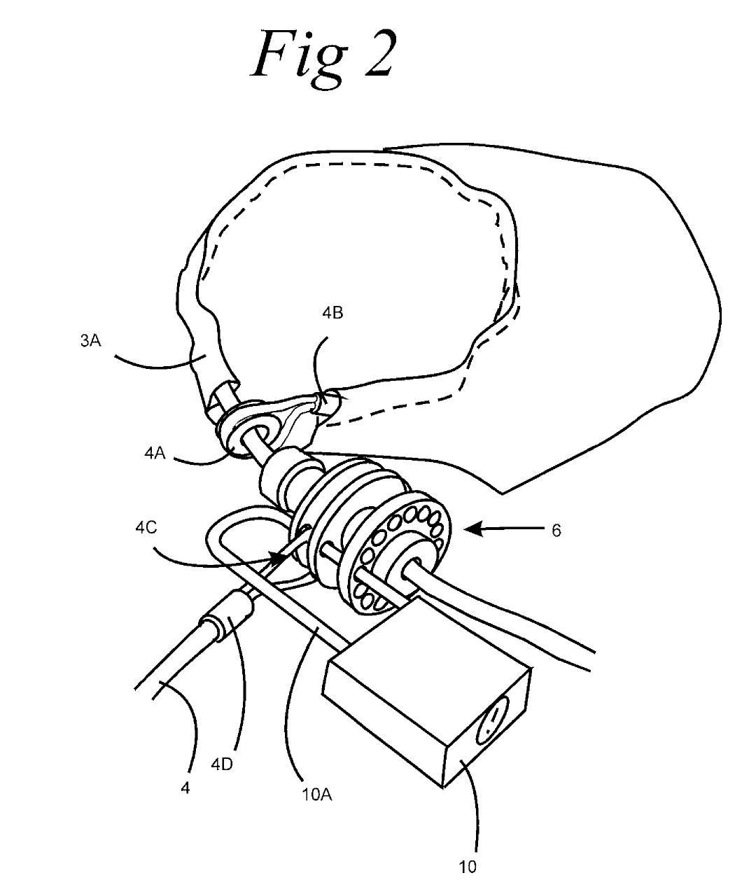

Referring first to FIGS. 1 & 2 a set of golf clubs 1 is held, as is conventional, in a stand/trolley 2 provided with carrying handle 2A, legs 2B and collapsible struts 2C.

The heads of the clubs are protected by a flexible hood 3 made from flexible woven fabric.

A novel locking device includes a cable 4 having an inner core of twisted galvanised steel and a smooth PVC outer sheath. The outer sheath is removed to expose the steel core at each end.

The exposed inner core at one end of the cable is wrapped around an eye 4A and is secured to itself by a crimped ferrule 4B. The cable passes through the seam 3A and through the eye 4A to form a noose allowing the opening of the hood to be drawn closed.

The cable 4 passes through the handle 1A and through an anchoring loop 5A attached to a wall 5 or any other fixed object. The opposite, free end of the cable is bent over so as to form a loop 4C and is secured by a crimped ferrule 4D.

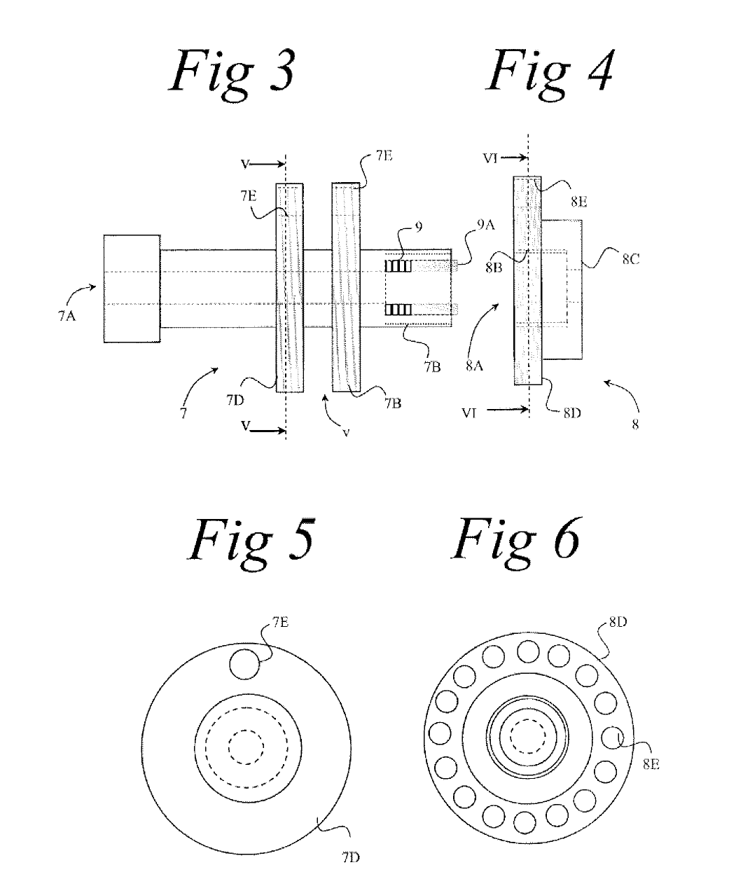

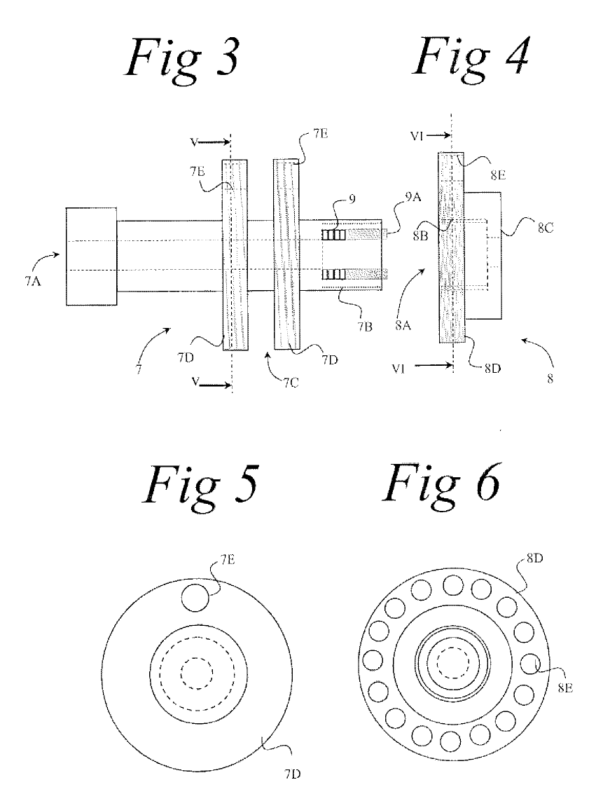

Referring to FIGS. 3 to 6, the locking sleeve 6 is formed from co-axial brass metal bushes 7 and 8. The bush 7 has a central bore 7A of slightly larger diameter than the cable 4, one end of this bore 7A being of enlarged diameter to receive a number of pressure application members in the form of washers 9. These are made of resiliently deformable material such as rubber or synthetic rubber. The enlarged part of the bore 7A also receives a pressure transfer cylinder 9A of PTFE. One end of this cylinder extends marginally from the end of the bore 7A and each of the parts 9 and 9A has a bore of the same diameter as bore 7A.

The bush 7 has an external thread 7B and has an annular space 7C defined between two knurled annular flanges 7D. This space 7C is designed to receive the loop 4C at the free end of the cable 4.

The bush 8 has an internal thread 8B, that co-operates with an external thread 7B of the bush 7, and an end flange 5C defining an opening of the same diameter as the bore 6A to allow passage of the cable 4. The bush 8 also has a knurled annular flange 8D formed with a large number of bores 8E (FIG. 6).

To secure the clubs 1 and the stand 2, all that needs to be done is to place the hood 3 over the club heads and to draw the noose tight around the shafts of the clubs by sliding the sleeve 6 so as to close the noose. The two parts 7 and 8 of the sleeve are then screwed together by relative turning the knurled flanges 7D and 8D by hand. This action causes the pressure transfer cylinder 9A to compress the washers 9 in an axial direction, causing them to swell radially inwardly and to press against the cable. The pressure obtained in this way, with only a moderate effort, is sufficient to lock the sleeve against the cable so that the noose cannot be loosened by a thief without the use of exceptional force.

Finally, the shackle 10A of a padlock 10 is passed through the bores 7E and through that one of the many bores SE that is aligned with the bores 7E when the sleeve 6 has been tightened onto the cable. The padlock is then locked in position making it very difficult for a thief to remove either the clubs or the stand/trolley.

While it is apparent that the illustrative embodiments of the invention herein disclosed fulfil the objectives stated above, it will be appreciated that numerous modifications and other embodiments may be devised by those skilled in the art. Therefore, it will be understood that the appended claims are intended to cover all such modifications and embodiments which come within the spirit and scope of the present invention.

1. A locking device comprising:
a flexible cable with a first end formed in a loop and a second end formed in a noose for holding one or more objects to be secured; and a locking sleeve that can be adjusted between a released condition in which it can slide
along the cable to tighten or loosen the noose and a secured condition in which it is restricted from sliding along the cable; and locking means for locking the sleeve in its secured condition thereby preventing a movement of the sleeve from its second condition to its release condition.

2. A locking device according to claim 1 characterised in that the noose passes through a guide or guides located around an opening of a flexible hood or cover so that the opening is drawn closed when the noose is tightened.

3. A locking device according to claim 1 characterised by means for locking another end of the cable to the sleeve so as to form a loop to attach the cable to an immovable object.

4. A locking device according to claim 1 characterised in that the locking sleeve comprises two parts having axial passages through which the cable passes, the two parts having co-operating screw threads, co-axial with the cable where it passes through the passages, allowing them to be screwed one into the other; the locking device also including a compression means that surrounds the cable and is so designed that it is forced against the cable to create a frictional locking action when the parts are screwed relative to each other.

5. A locking device according to claim 4 characterised in that the locking device is adapted to lock the two screw threaded parts against turning movement in a direction such as to release the locking action.

6. A locking device according to claim 5 characterised in that the screw threaded parts have holes which are in alignment when in the secured condition of rotation; and in which the locking means includes a shaft which passes through the holes which have been aligned.

7. A locking device according to claim 6 characterised in that the second end of the cable with the noose is formed with an eye such that the eye can be aligned with the holes allowing the shaft also to pass through the eye.

8. A mechanism for making a physical attachment to locking device for a flexible cable
characterised by a sleeve through which the cable passes, the sleeve being formed from two co-axial screw threaded members which are co-axial with the cable where it passes through the sleeve and a pressure application member constructed and arranged so that, when the screw threaded members are turned, one relative to the other, the pressure application member deforms and is pressed against a surface of the cable thereby locking the mechanism at its current position along the cable.

9. A cable locking device comprising:
a locking sleeve with a first member and a second member;
the first member having a first end and a second end and a central bore formed longitudinally therein with a given diameter sized for passing a cable therethrough,
wherein the second end has at least one transfer cylinder bore of a given depth from the second end which is co-axially aligned with and in communication with the central bore; and
deformable material placed in the transfer cylinder bore;
at least one transfer cylinder with a first end and a second end for insertion in the transfer cylinder bore to be in contact with the deformable material so as to at least partially protrude into the central bore when deformed by the transfer cylinder; and
the second member forming a cap when cooperatively co-axially coupled with the second end of the first member in at least a release position and a secure position, the second member having a central bore formed longitudinally therein with a given diameter substantially a same size as the central bore of the first member;
wherein, in the release position the cap does not urge the transfer cylinder against the deformable material so as to at least partially protrude into the central bore when deformed by the transfer cylinder; and
wherein, in the secure position the cap urges the transfer cylinder against the deformable material so as to at least partially protrude into the central bore when deformed by the transfer cylinder.

10. The cable locking device according to claim 9, where the second end of the first member includes threads formed thereon and the first end of the second member includes threads to be screwed onto the threads of the second end of the first member.

11. The cable locking device according to claim 9, where the deformable material is rubber.

12. The cable locking device according to claim 9, wherein the first member includes a pair of knurled flanges radially disposed thereon.

13. The cable locking device according to claim 12, further comprising:
a cable with a first end formed in a loop and a second end formed in a noose for holding at least one object to be secured and wherein the pair of knurled flanges radially are disposed at a given distance to receive the loop of the cable therebetween.

14. The cable locking device according to claim 13, further wherein the second member includes at least one knurled flange radially disposed thereon with a plurality of bores formed therein and co-axially aligned with the central bore of the second member.

15. The cable locking device according to claim 14, further wherein the pair of knurled flanges includes at least one bore that aligns with at least one of the plurality of bores in the knurled flange of the second when the first member and the second member are in the secure position.

16. The cable locking device according to claim 14, further comprising:
a hood with a single opening with a seam disposed around the opening, the seam sized to hold within the noose of the second end of the cable.

17. A cable locking device comprising:
a cable with a first end formed in a loop and a second end formed in a noose for holding at least one object to be secured;
a locking sleeve with a first member and a second member;
the first member having a first end and a second end and a bore formed longitudinally therein with a given diameter sized for passing the cable therethrough; and
wherein the second end has a bore of a given depth from the second end so that the bore for at least a portion of the given depth in the second end is larger than the given diameter in the first end,
deformable material placed at least partially circumferentially around the cable in the bore in the second end;
at least one transfer cylinder with a first end and a second end for insertion in the second end of the first member to be in contact with a the deformable material to radially bear against the cable when deformed by the transfer cylinder and the second end of the transfer cylinder projecting beyond the second end of the first member;
the second member forming a cap when cooperatively co-axially coupled with the second end of the first member in at least a release position and a secure position, the second member having a bore formed longitudinally therein with a given diameter sized for passing the cable therethrough;
wherein, in the release position the cap does not urge the transfer cylinder against the deformable material so as to radially bear against the cable, thereby allowing the cable to move through the bore; and
wherein, in the secure position the cap urges the transfer cylinder against the deformable material so as to radially bear against the cable, thereby restricting the cable to move through the bore.
